(19) United States
(12) Patent Application Publication
(10) Pub. No.: US 2011/0162929 A1
(43) Pub. Date: Jul. 7, 2011

(54) HYDRAULIC BRAKE SYSTEM

(75) Inventor: Wayne-Ian Moore, Changhua County (TW)

(73) Assignee: ASHIMA LTD., Changhua County (TW)

(21) Appl. No.: 12/907,029

(22) Filed: Oct. 19, 2010

(30) Foreign Application Priority Data
Jan. 6, 2010 (TW) 099100159

(51) Int. Cl. B62L 3/02; B60T 7/08; B60T 11/10

(52) U.S. Cl. 188/344

(57) ABSTRACT

A hydraulic brake system includes a bicycle steering assembly having a head tube, a connecting member connected with the head tube and a handlebar mounted on the connecting member. The connecting member has a receiving portion disposed therein. A hydraulic device is mounted in the receiving portion. The hydraulic device includes a hydraulic braking mechanism and at least one connecting tube connected with the hydraulic braking mechanism. A braking device is adapted to mount on a wheel of the bicycle. The at least one connecting tube is connected with the braking device. Two brake levers are respectively mounted on two ends of the handlebar. Each brake lever has a brake cable connected therewith. The brake cable has one end connected to a corresponding brake lever and the other end connected to the hydraulic brake mechanism for relatively driving the brake device.

### BACKGROUND OF THE INVENTION

1. Field of the Invention

The present invention relates to a brake system, and more particularly to a holder for a hydraulic brake system used for reducing volume and weight.

2. Description of Related Art

A conventional brake system has a mechanical structure and is relied on leverage to pull a cable. However, the conventional mechanical system requires a lot of element such that it is inconvenient to assemble the conventional mechanical system. The various elements also cause the conventional mechanical system to be unstable. Furthermore, the conventional mechanical system is simultaneously operated. All elements are operated together such that it takes strenuous strength for a user. Each element is related to other elements such the tolerance and gaps between the elements will consume the braking effect.

A conventional hydraulic brake system includes two brake devices respectively mounted on two handlebars of a bike and two hydraulic devices respectively mounted on the two brake devices. The two brake devices positioned on two handlebars are dominated with a front brake assembly and a rear brake assembly. However, each hydraulic device has hydraulic fluid filling therein such that the two hydraulic devices are heavy. The two hydraulic device are also increased the size of the handlebars. Those are not suitable for the requirement of the light weight bike. Furthermore, the form of the handlebar is adjusted due to the hydraulic device mounted on the handlebar. This costs a lot to re-thread the handlebar and increases a manufacturing fee of each bike. The stability of the structure of the conventional hydraulic brake system is decreased. Besides, the conventional hydraulic brake system is not able to mount on a mountain bike. The mountain bike has a derailleur mechanism mounted on the handlebar. The derailleur mechanism includes a transmission lever and a transmission cable. Therefore, a receiving space of the handlebar is more decreased and is not able to assemble with the conventional hydraulic brake system.

The present invention has arisen to mitigate and/or obviate the disadvantages of the conventional brake system.

### SUMMARY OF THE INVENTION

The main objective of the present invention is to provide an improved hydraulic brake system which is extensive utilized in all kinds of bike.

To achieve the objective, the hydraulic brake system comprises a bicycle steering assembly. The bicycle steering assembly includes a head tube, a connecting member connected with the head tube and a handlebar mounted on the connecting member. The connecting member has a receiving portion disposed therein. A hydraulic device is mounted in the receiving portion. The hydraulic device includes a hydraulic braking mechanism and at least one connecting tube connected with the hydraulic braking mechanism. The hydraulic braking mechanism has a hydraulic container mounted in the connecting member. The hydraulic container has two hydraulic tanks disposed therein for receiving fluid. The hydraulic container has two first connecting holes defined in a bottom thereof for respectively communicating with the two hydraulic tanks. Two connectors pass through the connecting member and are respectively connected with the two first connecting holes. Each connector has one end connected with a corresponding first connecting hole and the other end connected with the connecting tube. Two pistons are respectively received in the two hydraulic tanks. Two elastomers are respectively mounted on the two pistons. The hydraulic container has a second connecting hole defined in a top thereof A fluid tank is mounted on the hydraulic container and communicated with the second connecting hole for storing fluid and replenishing the fluid in the hydraulic tank. A braking device is adapted to mount on a wheel of the bicycle. The at least one connecting tube is connected with the braking device for hydraulically driving the braking device to provide a braking effort. Two brake levers are respectively mounted on two ends of the handlebar. Each brake lever has a brake cable connected therewith. Each brake cable has one end connected to a corresponding brake lever and the other end connected to a corresponding piston in the hydraulic brake mechanism for relatively driving the brake device.

In accordance with another aspect of the present invention, the hydraulic brake system in accordance with the present invention is mounted on the head tube.

Further benefits and advantages of the present invention will become apparent after a careful reading of the detailed description with appropriate reference to the accompanying drawings.

### BRIEF DESCRIPTION OF THE DRAWINGS

FIG. 1 is an exposed perspective view of a hydraulic brake system in accordance with the present invention;

FIG. 1A is a perspective view of a hydraulic container in another direction;

FIG. 2 is an assembled perspective view of the hydraulic brake system in accordance with the present invention;

FIG. 3 is a cross-sectional view of the hydraulic brake system of the present invention taken along line III-III in FIG. 2;

FIG. 4 is a perspective assembled view of the hydraulic brake system in accordance with the present invention;

FIG. 5 is an operational view of the hydraulic brake system in accordance with the present invention;

FIG. 6 is an operational view of the hydraulic brake system in accordance with the present invention utilized on a racing bike; and

FIG. 7 shows an operational view of the hydraulic brake system of a second embodiment in accordance with the present invention.

### DETAILED DESCRIPTION OF THE INVENTION

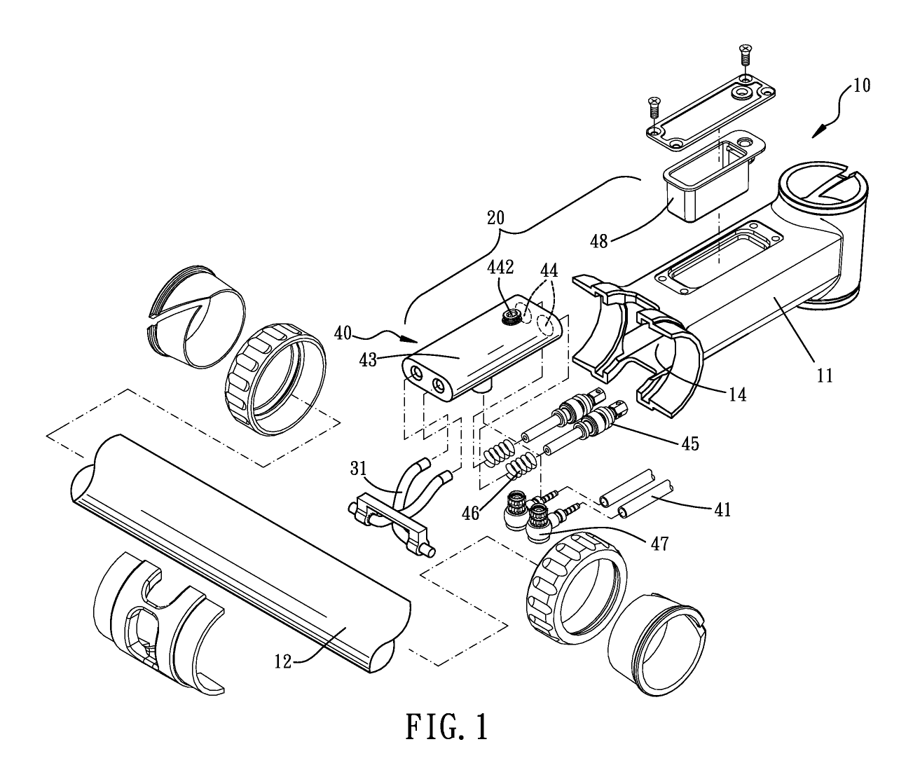

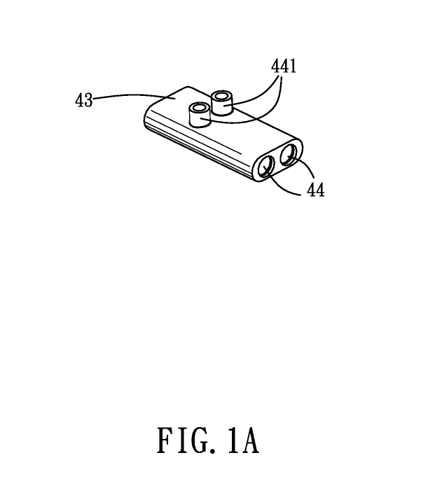

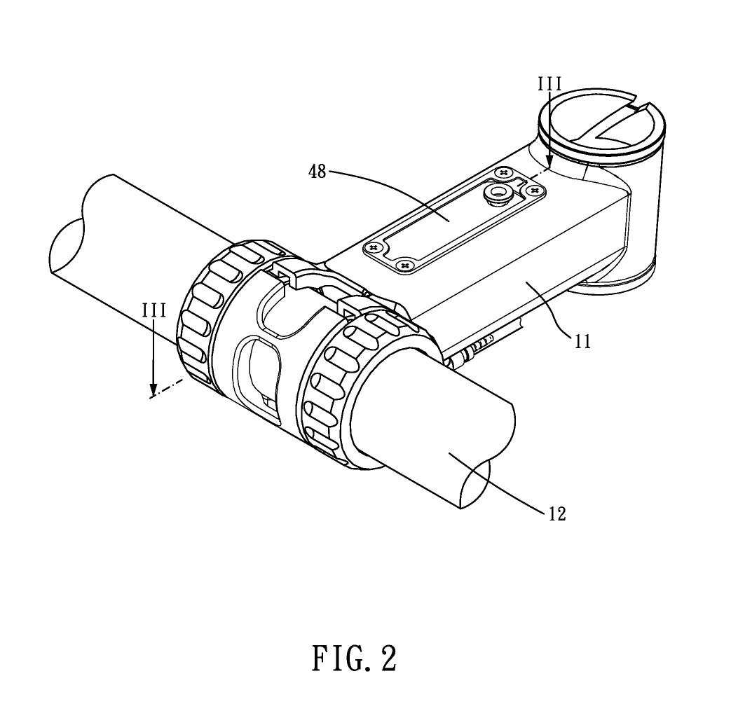

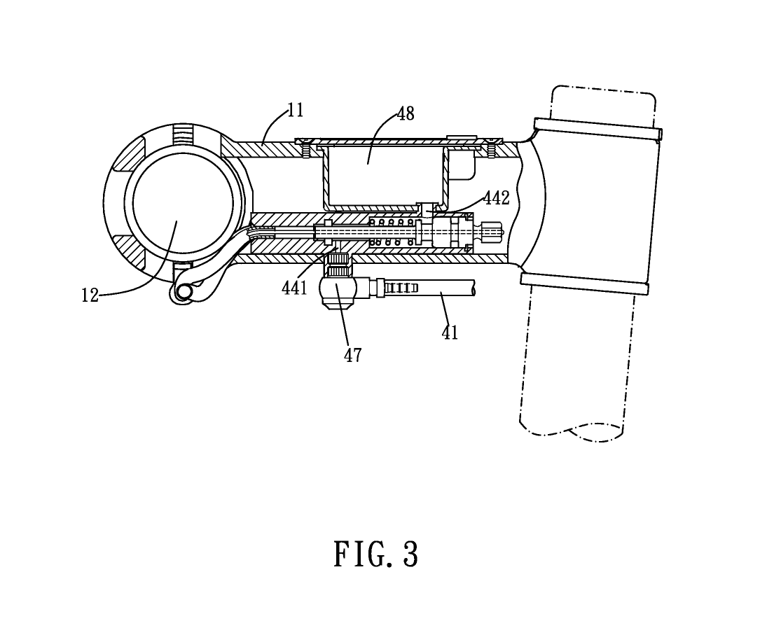

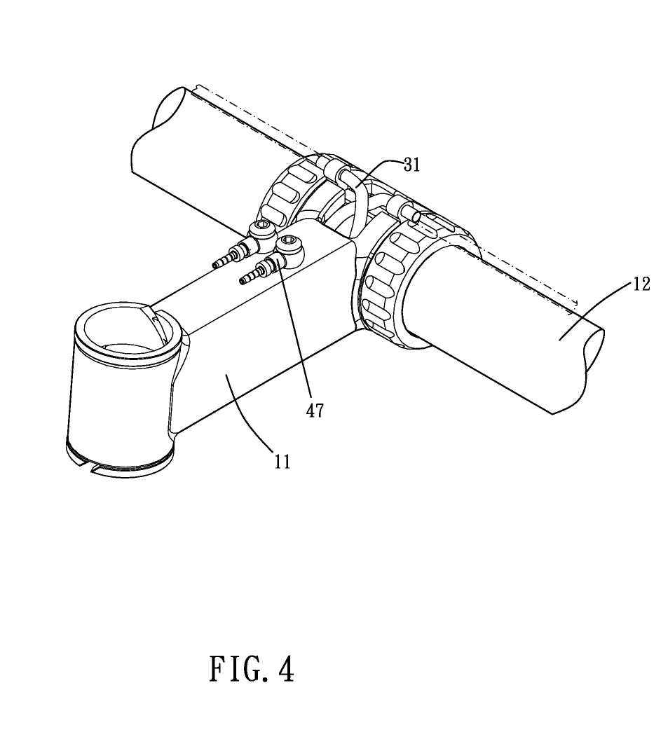

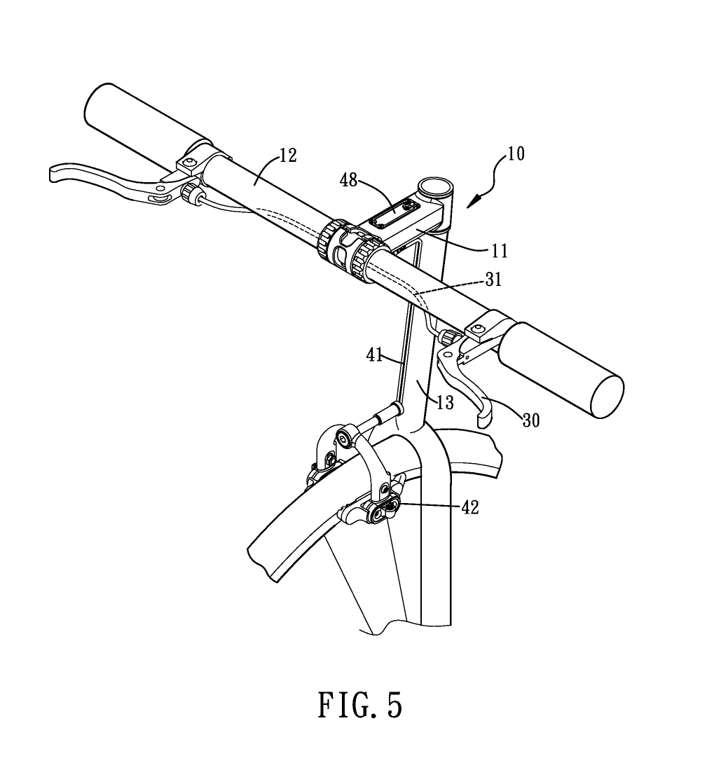

Referring to the drawings and initially to FIGS. 1-6, a hydraulic brake system in accordance with the present invention comprises a bicycle steering assembly 10. The bicycle steering assembly 10 includes a head tube 13, a connecting member 11 connected with the head tube 13 and a handlebar 12 mounted on the connecting member 11. In the preferred embodiment of the present invention, the connecting member 11 can be a stem, or a head tube. The connecting member 11 has a receiving portion 14 disposed therein. A hydraulic device 20 is mounted in the receiving portion 14. The hydraulic device 20 includes a hydraulic braking mechanism 40 and at least one connecting tube 41 connected with the hydraulic braking mechanism 40. The hydraulic braking mechanism 40 has a hydraulic container 43 mounted in the connecting member 11. The hydraulic container 43 has two hydraulic tanks 44 disposed therein for receiving fluid. The hydraulic container 43 has two first connecting holes 441 defined in a bottom thereof for respectively communicating with the two hydraulic tanks 44 (shown in FIG. 1A). Two connectors 47 pass through the connecting member 11 and are respectively connected with the two first connecting holes 441. Each connector 47 has one end connected with a corresponding first connecting hole 441 and the other end connected with the connecting tube 41. Two pistons 45 are respectively received in the two hydraulic tanks 44. Two elastomers 46 are respectively mounted on the two pistons 45. The hydraulic container 43 has a second connecting hole 442 defined in a top thereof A fluid tank 48 is mounted on the hydraulic container 43 and communicated with the second connecting hole 442 for storing fluid and replenishing the fluid in the hydraulic tank 44. A braking device 42 is adapted to mount on a wheel of the bicycle. The at least one connecting tube 41 is connected with the braking device 42 for hydraulically driving the braking device 42 to provide a braking effort. Two brake levers 30 are respectively mounted on two ends of the handlebar 12. Each brake lever 30 has a brake cable 31 connected therewith. Each brake cable 31 has one end connected to a corresponding brake lever 30 and the other end connected to a corresponding piston 45 in the hydraulic braking mechanism 40 for relatively driving the braking device 42.

When a user presses the brake lever 30 to pull the brake cable 31, the brake cable 31 pulls the piston 45 to press the fluid in the hydraulic tank 44 such that the fluid is flowed into the connector 47 via the first connecting hole 441 and guided into the connecting tube 41 for actuating the braking device 42.

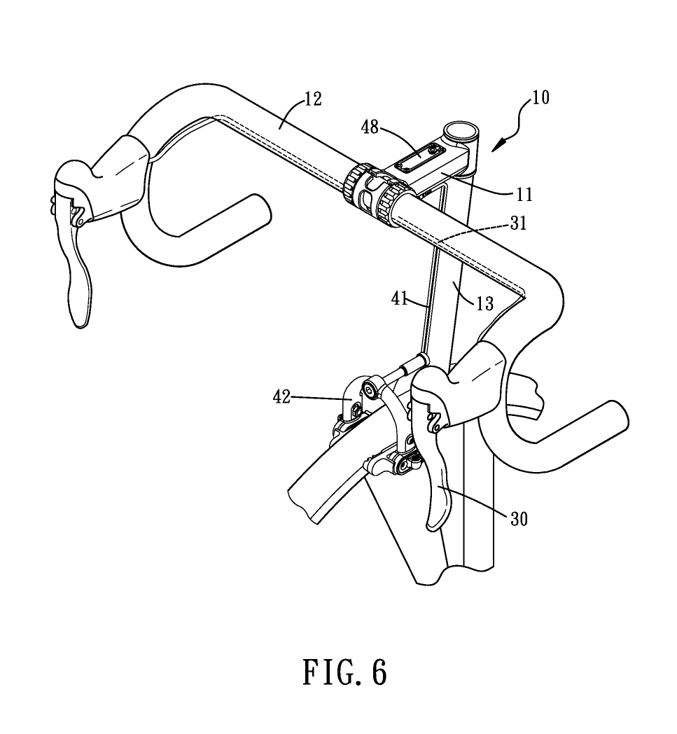

Referring to FIG. 6, the hydraulic brake system in accordance with the present invention can be utilized on a racing bike.

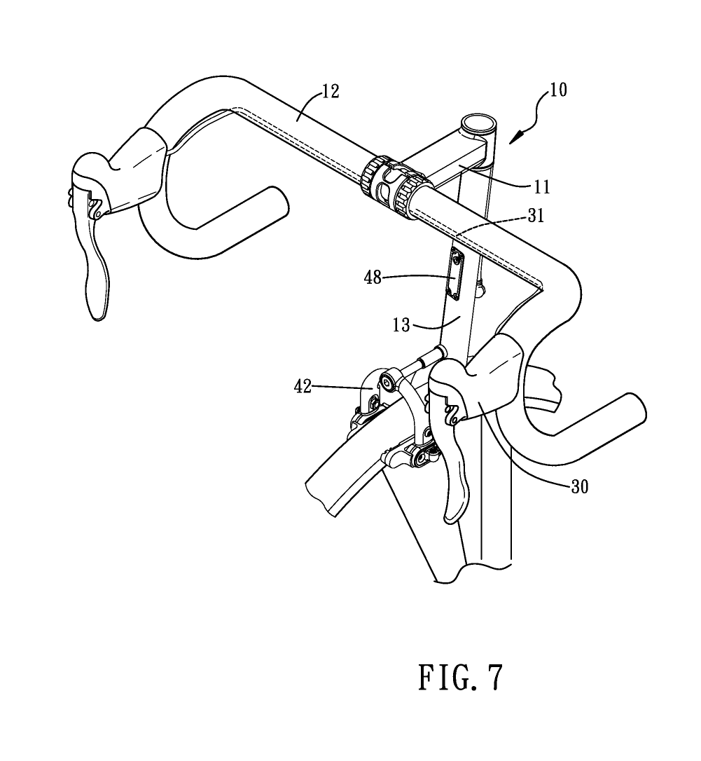

With reference to FIG. 7, that shows a second embodiment of the hydraulic brake system in accordance with the present invention. The elements and effects of the second embodiment which are the same with the first embodiment are not described, only the differences are described. The hydraulic brake system in accordance with the present invention is mounted on the head tube 13.

The hydraulic brake system in accordance with the present invention provides the following advantages:

1. The hydraulic brake system in accordance with the present invention can be utilized on any kind of element of the bicycle steering assembly 10, such as stem or head tube 13. The hydraulic brake system is not necessary to assemble with the handlebar 12. The weight and size of the bike can be reduced.

2. The hydraulic brake system in accordance with the present invention can be utilized on any kind of bike handlebar 12. The handlebar 12 of the bike doesn't need to be modified or changed. A diameter of the handlebar 12 does not need to be adjusted. Therefore, the structural strength and the stability of the bike are enhanced.

3. When a racing bike or a mountain bike utilizes the hydraulic brake system in accordance with the present invention, the braking device 42 and the derailleur of the bike are not necessary to be changed. Therefore, the hydraulic brake system in accordance with the present invention is widely extensive utilized.

Although the invention has been explained in relation to its preferred embodiment, it is to be understood that many other possible modifications and variations can be made without departing from the spirit and scope of the invention as hereinafter claimed.

What is claimed is:

1. A hydraulic brake system comprising:
a bicycle steering assembly, the bicycle steering assembly including a head tube, a connecting member connected with the head tube and a handlebar mounted on the connecting member, the connecting member having a receiving portion disposed therein;
a hydraulic device mounted in the receiving portion, the hydraulic device including a hydraulic braking mechanism and at least one connecting tube connected with the hydraulic braking mechanism;
a braking device adapted to mount on a wheel of the bicycle, the at least one connecting tube connected with the braking device for hydraulically driving the braking device to provide a braking effort;
two brake levers respectively mounted on two ends of the handlebar, each brake lever having a brake cable connected therewith, the brake cable having one end connected to a corresponding brake lever and the other end connected to the hydraulic brake mechanism for relatively driving the brake device.

2. The hydraulic brake system as claimed in claim 1, wherein the hydraulic braking mechanism has a hydraulic container mounted in the connecting member, the hydraulic container having two hydraulic tanks disposed therein for receiving fluid, the hydraulic container having two first connecting holes defined in a bottom thereof for respectively communicating with the two hydraulic tanks, two connectors passing through the connecting member and respectively connected with the two first connecting holes, each connector having one end connected with the corresponding first connecting hole and the other end connected with the corresponding connecting tube, two pistons respectively received in the two hydraulic tanks and respectively connected with two brake cables, two elastomers respectively mounted on the two pistons; wherein when a user presses the brake lever to pull the brake cable, the brake cable pulls the piston to press the fluid in the hydraulic tank such that the fluid is flowed into the connector via the first connecting hole and guided into the connecting tube for actuating the brake device.

3. The hydraulic brake system as claimed in claim 2, wherein the hydraulic container has a second connecting hole defined in a top thereof, a fluid tank mounted on the hydraulic container and communicated with the second connecting hole for storing fluid and replenishing the fluid in the hydraulic tank.
